(19) United States
(12) Patent Application Publication
(10) Pub. No.: US 2023/0186175 A1
(43) Pub. Date: Jun. 15, 2023

(54) RETRAINING BASED ON CHALLENGER MODEL COMPARISON

(71) Applicant: DataRobot, Inc., Boston, MA (US)

(72) Inventors: Bohdan Usatov, Boston, MA (US); Chris Li, Boston, MA (US); Evan Chang, Boston, MA (US); Tristan Spauding, Boston, MA (US); Christopher Cozzi, Halifax, CA (US)

(73) Assignee: DataRobot, Inc., Boston, MA (US)

(21) Appl. No.: 18/078,584

(22) Filed: Dec. 9, 2022

Related U.S. Application Data
(60) Provisional application No. 63/288,458, filed on Dec. 10, 2021.

(51) Int. Cl. G06N 20/20; G06F 18/21; G06F 18/22

(52) U.S. Cl. CPC G06N 20/20; G06F 18/217; G06F 18/22

(57) ABSTRACT

Comparing a challenger model with a primary model is provided herein. In an embodiment, a system comprises one or more processors, coupled to memory, configured to determine, based on a comparison of a first model that is deployed as a primary model with a second model that is acting as a challenger model, that the second model performs better than the first model based on at least one performance metric; determine, based on a comparison of a characteristic of the first model with a characteristic of the second model, to skip a validation process for the second model; and establish the second model as the primary model in the deployment to replace the first model in the deployment.

### CROSS REFERENCE TO RELATED APPLICATIONS

This application claims the benefit of priority under 35 U.S.C. § 119 to U.S. Provisional Patent Application No. 63/288,458, filed on Dec. 10, 2021, which is incorporated herein by reference in its entirety for all purposes.

### FIELD OF THE DISCLOSURE

This disclosure relates generally to retraining a machine learning based on a comparison with a challenger model.

### BACKGROUND

Machine learning is being integrated into a wide range of use cases and industries. Unlike certain other applications, machine learning applications (including deep learning and advanced analytics) can have multiple independent running components that operate cohesively to deliver accurate and relevant results. This complexity can make it difficult to manage or monitor all the interdependent aspects of a machine learning system.

In some instances, for example, data for a machine learning model can be provided in a data stream of unknown size and/or having thousands or millions of numerical values per hour, and lasting for several hours, days, weeks, or longer. Failing to properly store, process, or aggregate such data streams can result in catastrophic failures in which data is lost or models are otherwise unable to make predictions. Additionally, such data can drift over time to be significantly different from data that was used to train the model. This can result can model performance issues and may require the model to be retrained and/or a different model to be utilized.

### SUMMARY

This technical solution is directed to systems and methods of retraining machine learning models based on comparisons with a challenger model. This technical solution can provide insights regarding a challenger machine model. For example, a machine learning model can be trained based on historical data. Upon training the model, the model can be deployed or used to generate output based on received input. In some cases, a data processing system can generate multiple machine learning models using different machine learning techniques. The various machine learning models can be evaluated to determine how well the models perform against certain input data using one or more performance scores or techniques. Performance scores can be based on accuracy, consistency, reliability, speed, or computing resource utilization (e.g., memory utilization, processor utilization, network bandwidth utilization, battery or power utilization, etc.). Upon identifying a best performing model among the different models, the data processing system can establish a model as a primary or active model. Due to changes in the input data over time, drift, or other technical discrepancies, one of the different models (e.g., a challenger model) may perform better. However, due to the various performance criteria, performance techniques, or complexities associated with monitoring model performance, it can be challenging to compare performance of the primary model with a challenger model during deployment. Additional technical challenges or inefficiencies can be introduced by inadvertently or prematurely making a challenger model the primary model when the challenger model may not perform better or provide similar results to the primary model

Thus, systems and methods of this technical solution can efficiently, accurately, or reliably determine which of the primary or one or more challenger models is performing better, thereby allowing a data processing system of this technical solution to concretely compare the performance between different models using insights.

At least one aspect is directed to a system. The system can include one or more processors coupled to memory. The system can determine, based on a comparison of a first model that is deployed as a primary model with a second model that is acting as a challenger model, that the second model performs better than the first model based on at least one performance metric. The system can determine, based on a comparison of a characteristic of the first model with a characteristic of the second model, to skip a validation process for the second model. The system can establish the second model as the primary model in the deployment to replace the first model in the deployment.

In some cases, the characteristic can include a blueprint. The characteristic can include a hyperparameter. The characteristic can include an order of operations.

The system can determine, based on the first model, one or more performance metrics to use for the comparison of the first model with the second model. The system can provide the determined one or more performance metrics for presentation via a prompt output by a graphical user interface rendered on a client device. The system can receive, responsive to the prompt, a selection of the at least one performance metric from the one or more performance metrics provided via the prompt.

The system can detect, subsequent to deployment of the second model as the primary model, an error with output or performance of the second model. The system can return, responsive to the detection, the first model as the primary model in the deployment.

The system can provide, responsive to the determination that the second model performs better than the first model and to skip the validation process, a prompt to a client device to request authorization to establish the second model as the primary model in the deployment. The system can establish the second model as the primary model in the deployment responsive to receiving authorization from the client device via the prompt. In some cases, the at least one performance metric comprises at least one of speed of performance, accuracy, or computation resource utilization. The system can determine the first model performs better than the second model based on the second model generating output with a same accuracy faster than the first model.

An aspect of this technical solution can be directed to a method. The method can be performed by one or more processors. The method can include determining, based on a comparison of a first model that is deployed as a primary model with a second model that is acting as a challenger model, that the second model performs better than the first model based on at least one performance metric. The method can include determining, based on a comparison of a characteristic of the first model with a characteristic of the second model, to skip a validation process for the second model. The method can include establishing the second model as the primary model in the deployment to replace the first model in the deployment.

An aspect of this technical solution can be directed to non-transitory computer-readable medium storing processor-executable instructions that, when executed by one or more processors, causes the one or more processors to determine, based on a comparison of a first model that is deployed as a primary model with a second model that is acting as a challenger model, that the second model performs better than the first model based on at least one performance metric. The instructions can include instructions to determine, based on a comparison of a characteristic of the first model with a characteristic of the second model, to skip a validation process for the second model. The instructions can include instructions to establish the second model as the primary model in the deployment to replace the first model in the deployment.

### BRIEF DESCRIPTION OF THE DRAWINGS

These and other aspects and features of this disclosure will become apparent to those ordinarily skilled in the art upon review of the following description of specific implementations in conjunction with the accompanying figures, wherein:

FIG. 1 illustrates a method for comparing models.

FIGS. 2A-2E illustrate graphical user interfaces for presenting insights for challenger models.

FIGS. 3-15 illustrate graphical user interfaces for comparing models in accordance with implementations.

FIG. 16 is a block diagram illustrating an architecture for a computer system that can be employed to implement elements of the systems, methods and graphical user interfaces described and illustrated herein, including, for example, the method depicted in FIG. 1 and the graphical user interfaces depicted in FIGS. 2A-15.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This technical solution provides a model comparison framework configured to compare a primary machine learning model with a challenger machine learning model. The primary model can refer to a model that is currently being used in a deployment. A deployment with regard to a machine learning model may refer to use of a developed machine learning model to generate real-world predictions. A deployed, primary machine learning model may have completed development (e.g., training). A model can be deployed in any system, including the system in which it was developed and/or a third-party system. A deployed machine learning model can make real-world predictions based on a scoring data set. Unlike certain embodiments of a training data set, scoring data set generally does not include known outcomes. Rather, the deployed machine learning model can be used to generate predictions of outcomes based on the scoring dataset.

Due to the technical problems or errors that can be introduced as a result of prematurely or incorrectly replacing a primary model with a challenger model, this technical solution provides a challenger framework in which to compare different models using various insights. The challenger framework can inspect the models based on composition, reliability, or behavior of the two models.

This technical solution provides a challenger framework for machine learning operations (MLOPs) that can include a platform-independent environment for the deployment, management, and control of statistical, rule-based, and predictive models. The subject matter can include computer-implemented modules or components for performing data aggregation for data streams, drift identification, drift monitoring, and model management and control.

The challenger framework of this technical solution can allow two models to be selected (e.g., a primary or champion model versus a challenger model) and insights to be generated comparing the two models. This is accomplished by computing predictions on a shared set of inference data between the models (e.g., user provided, project sourced, or monitored inference/actuals). The framework can provide insights in a scalable manner. The framework can support different types of models including, for example, binary classification and regression. To do so, this technical solution can include one or more component or functionality depicted in Appendix A, which is incorporated herein by reference in its entirety for all intents and purposes.

The challenger framework of this technical solution can provide various types of insights. The technical solution can generate comparison insights that include or are based on accuracy, lift, dual lift, receiver operating characteristic, or prediction difference.

The system can render the insights when they are computed for the different models on the same dataset and partition so that the insights are comparable. However, the models can be trained on different datasets, such as one model can be trained on an update snapshot of the same data source.

The system can compare a challenger model's feature impact to the champion model to indicate where the two models differ, and whether the difference indicates the challenger model is not plausible. The system can provide an indication of the observed drift of features to indicate how susceptible the challenger model may be to drift relative to the primary model, for example. The system can provide a comparison of the challenger model's predictions to the champion's on a row-by-row basis to indicate the different for individual entities.

Using the methods and systems discussed herein, a server/processor may replace a live model in deployment with another model. The methods discussed herein can allow users to inspect the composition, reliability, and behavior of the two models, champion and challenger models. For instance, using various graphical user interfaces, users can view accuracy value comparison of models using various accuracy metrics, such as Dual Lift Charts, Feature Impact Comparison, and/or Row level prediction difference between models.

Users can identify one or more datasets to compute the metrics on between the two models to be compared. The insights may be rendered when computed on the same dataset and partition so that they are fairly comparable. These models can be trained on different datasets, for example one on an update snapshot of the same data source.

When considering promoting a model over another model, users can view a dual lift chart of the models illustrating how the models over- or under-predict along the distribution of the predictions. This helps users decide whether to promote the model because the user may be interested more in one end of the spectrum.

When considering promoting a model over another model, users can compare the challenger model's feature impact to the champion model so that they can gain insights regarding where the two models are different and if that difference suggests the new model is implausible. Further, the user can understand the observed drift of the features to understand if the new model will be as susceptible to the drift seen by the old model.

The system may allow users to change the challenger or champion model in the comparison view so that they can continue the comparison without losing context (e.g., the system displays information regarding the role of the model being compared).

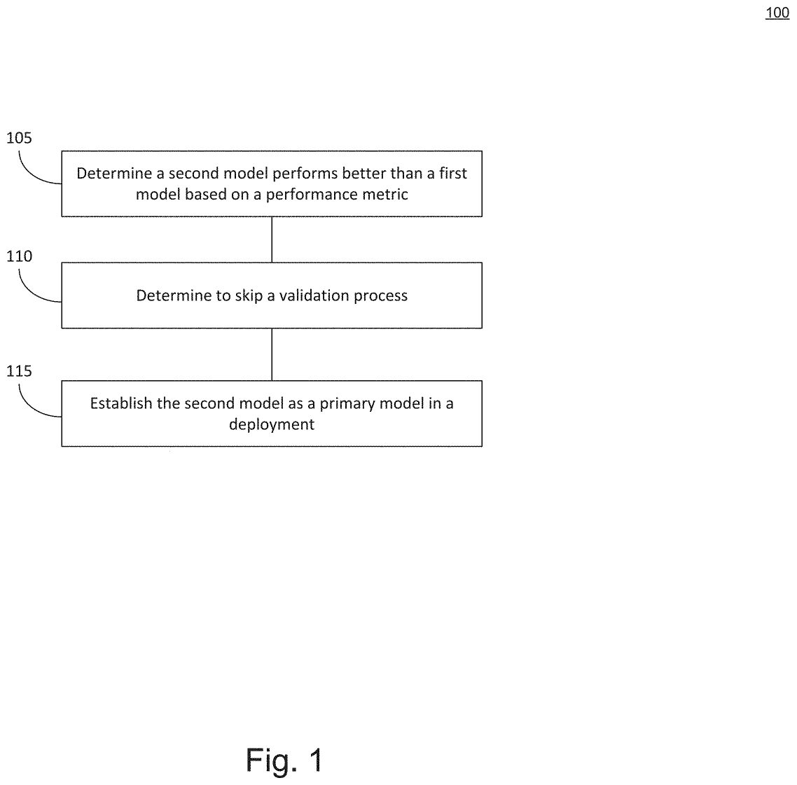

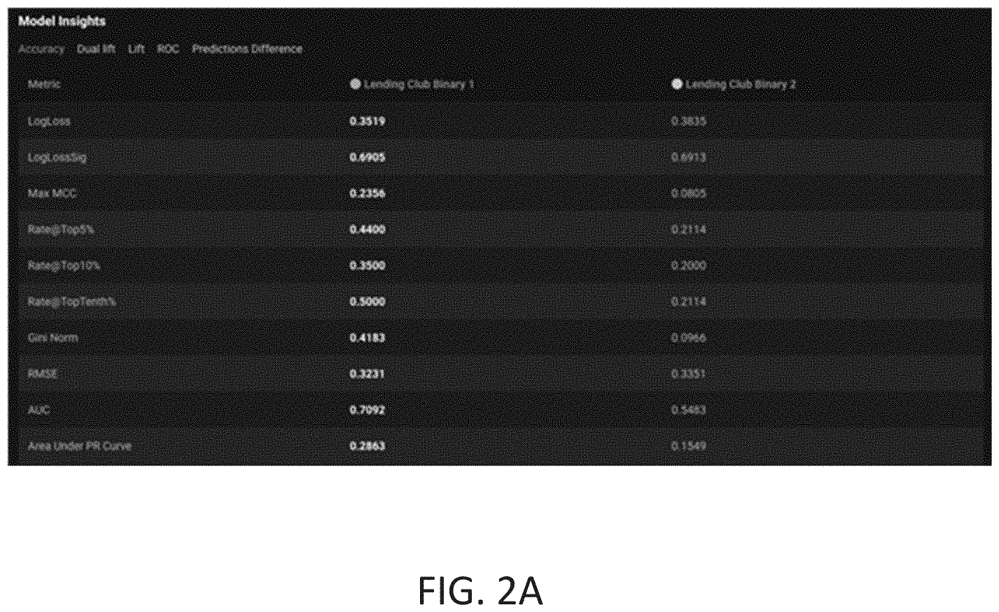

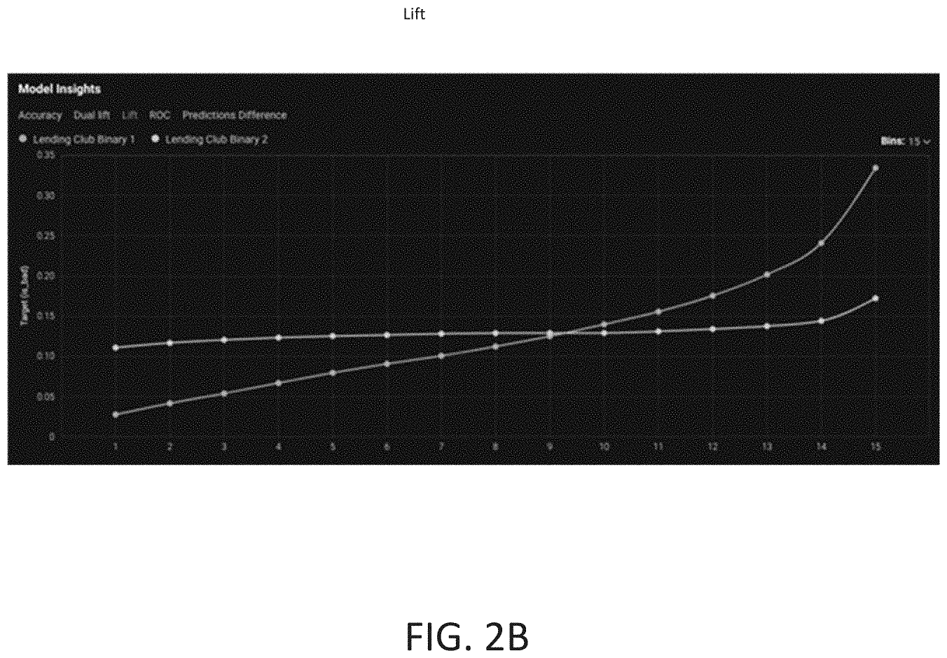

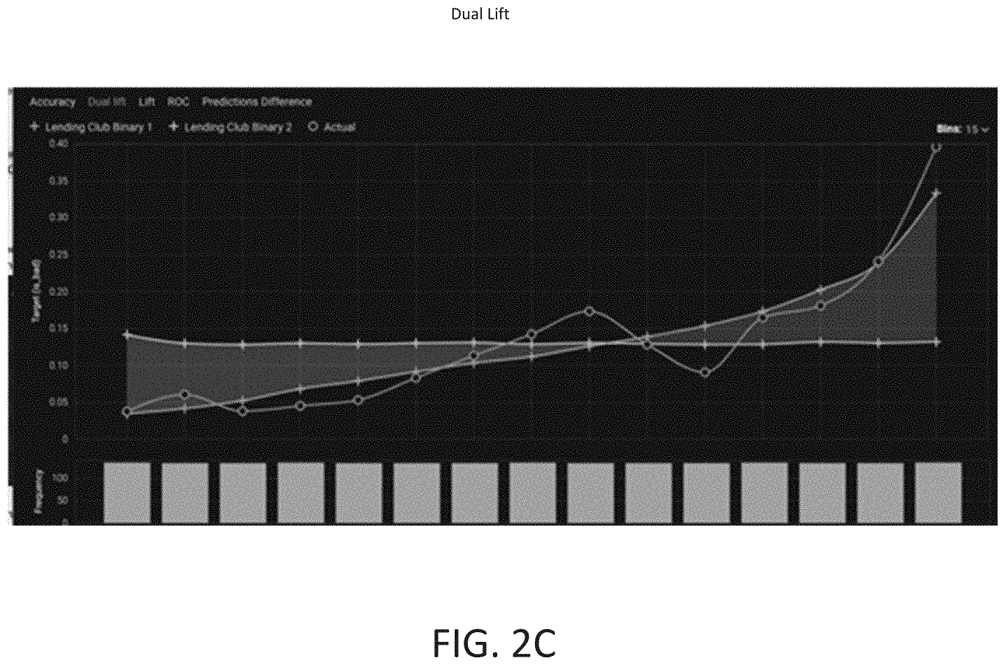

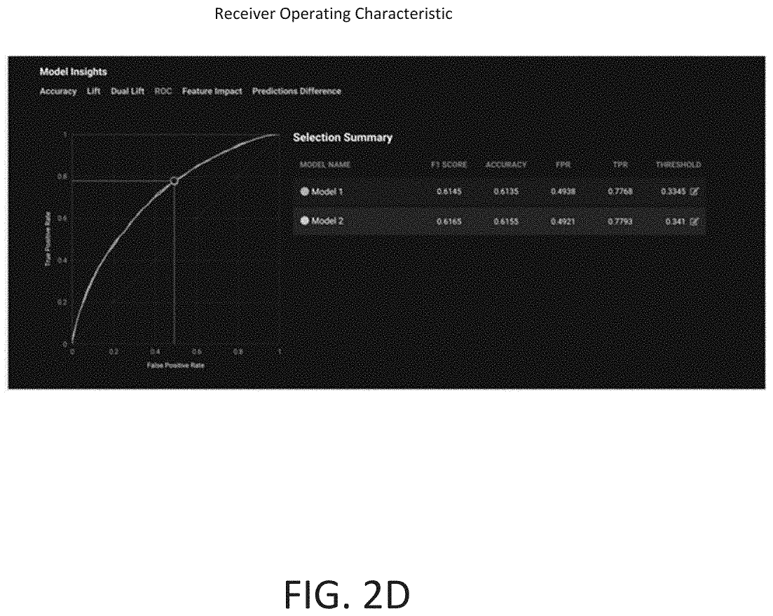

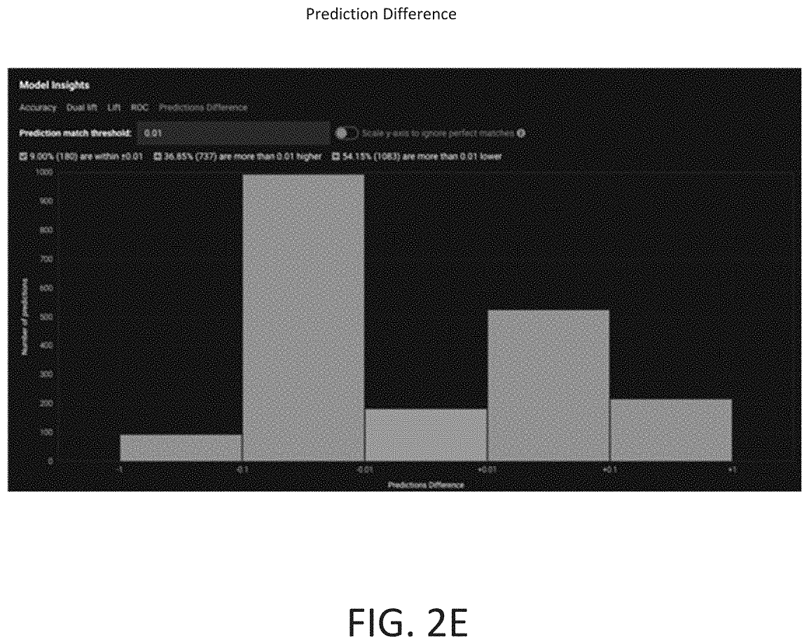

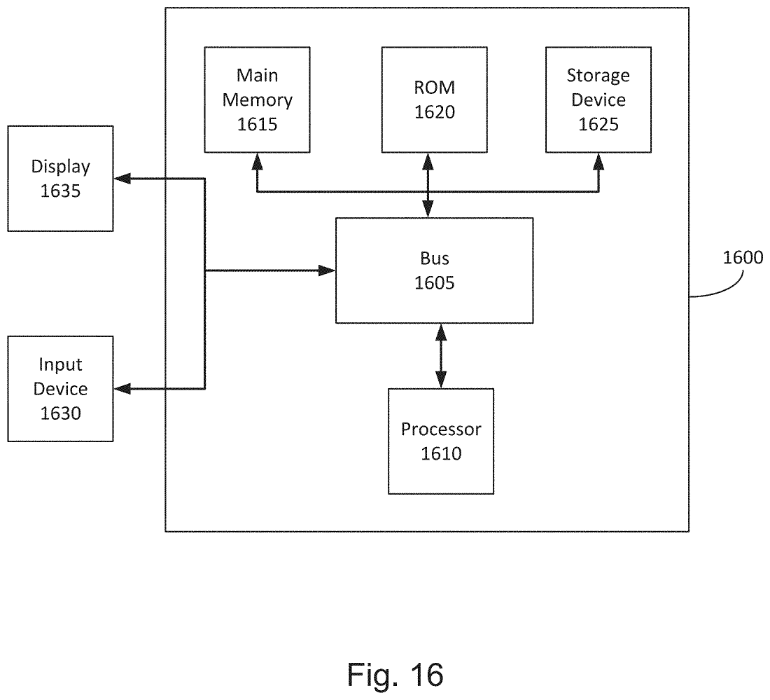

FIG. 1 depicts a method of comparing models, in accordance with an implementation. The method 100 can be performance by one or more component or system depicted herein, including for example computing system 1600 depicted in FIG. 16. At 105, the method can include determining, based on a comparison of a first model that is deployed as a primary model with a second model that is acting as a challenger model, that the second model performs better than the first model based on at least one performance metric. The system can make the determination based on one or more performance metrics. Performance metrics can include or be based on insights such as those depicted in FIGS. 2A-2E. For instance, the metrics compared may include speed of performance, accuracy, and/or computation resource utilization.

In some cases, a user can select the challenger model for the system to use in this challenger framework. For example, the system can automatically provide a list of models that are ranked based on performance metrics. The user can view the list of models and select one as a challenger model for this purpose. The user can include or indicate certain constraints which can be used to filter the available models. For example, a filter can be based on blueprints or hyperparemeters.

If a user selects a blueprint filter, then the system can identify models in the leaderboard that have the same blueprint as the primary model in the deployment. This can prevent or reduce validation checks should the system determine that the challenger model performs better than the primary model.

In another example, the user can select hyperparameters as a filter. This can filter the available challenger models to those having the same values for hyperparmeters as the primary model, which can prevent or reduce validations checks should the system determine that the challenger model performs better than the primary model. For instance, the second model may produce more accurate results and/or produce results faster. In some embodiments, the better model may output the same results (as far as being accurate) in less time or via using less computing power.

As used herein, “better” may refer to a model having a value that is higher or lower than a second value associated with a second model where the values correspond to the same attribute. “Better” may be determined based on the corresponding attribute. For instance, two models may be analyzed regarding their accuracy, time to predict results, lift values, or dual life values. Each model may be assigned a score. The model with a higher score may be designated as the better model. In another embodiment, two models may be assigned different scores for their drift. In that example, the model with the lower score may be designated as the better model. In some embodiments, the difference between the models may need to satisfy a difference threshold before one model is designated as better. For instance, if accuracy score of one model is only 2% higher than another model, then (because the difference threshold is set to 5% or above), the system may not designate the model with the lower score as the better model. In some embodiments, an input of which model is better is received via a user viewing the GUIs discussed herein.

In some embodiments, the system may automatically search for the best hyperparameters to optimize the first and/or the second models.

At 110, the method can include determining, based on a comparison of a characteristic of the first model with a characteristic of the second model, to skip a validation process for the second model. A characteristic can include hyperparemeters, constraints, or blueprints. A blueprint can refer to a set of operations performed by a model or used to generate, develop or train a model. For instance, a blue print may indicate how a model should operate, be trained, and/or identify its different connections (e.g., retrieve data from other models or data repositories). Therefore, blueprints may refer to machine learning pipelines containing preprocessing steps, modeling algorithms, and/or post-processing steps. They can be generated either automatically or using inputs from an end-user.

In some cases, the system can automatically validate the challenger model before promotion.

By skipping the validation process, the system may provide various technical advantages. For instance, not performing the validation process may maintain the reliability or accuracy of the system while reducing computing resource utilization associated with performing the validation process. Not performing the validation process may also allow the system to change models used in different pipelines in less time than needed by conventional methods.

As used herein, skipping may refer to foregoing, canceling, blocking, overriding, or not performing a validation process that is to be performed. In some embodiments, the system may perform a secondary or alternative validation process. For instance, instead of performing a validation process that consumed high computing resources, the system may perform an alternative validation process that has other attributes (e.g., less computing power or time needed or fewer data points are validated). The system may use the methods discussed herein instead of (and sometimes in conjunction with) a validation process. For instance, the system may use the method 100 for two different models and switch the models without needing to validate the challenger model.

At 115, the method can include establishing the second model as the primary model in the deployment to replace the first model in the deployment. The system can determine to provide a prompt requesting authorization from a user prior to activating the challenger model as the primary.

The system may determine whether to implement a validation check for the second model (e.g., the challenger model) based on one or more characteristics including the blueprint associated with the second model, hyperparameter associated with the second model, and/or an order of operations associated with the first and/or the second model.

In some embodiments, the system may display a list of performance metrics to be analyzed and display the list on a GUI. Upon receiving a selection from the user, the system may analyze the models corresponding to the selected performance metric (e.g., various GUIs illustrated herein).

In some embodiments, the system may display one or more GUIs (e.g., various GUIs depicted in FIGS. 2-16 illustrating how different models perform. These GUIs may allow a user to change models for different blueprints (pipelines). For instance, the system may receive an indication that the challenger is performing better than the primary model. As a result, the system may display various GUIs indicating a comparison for different models. Upon receiving authorization from a user, the system may deploy a selected model (e.g., as the primary model).

FIG. 2A illustrates a graphical user interface for providing an accuracy insight. The accuracy insight GUI can display calculated available accuracy metrics (based on model target type) for the different models being compared. The GUI can highlight a value that indicates a better accuracy value for a particular metric.

FIG. 2B illustrates a graphical user interface for providing a lift insight. The lift insight GUI can depict how effective a model is at predicting a target, providing a visualization of the effectiveness of the model.

FIG. 2C illustrates a graphical user interface for providing a dual lift insight. The dual lift insight GUI can display sorted predictions in increasing order, and group the sorted predictions into equal-sized bins. The system can provide dual lift insights for different types of models, including, for example, regression, binary classification, and multiclass. The GUI may displays sorted predictions in increasing order and then grouped into equal-sized bins, such that the user can compare performances of two models.

FIG. 2D illustrates a graphical user interface for providing a receiver operating characteristic (“ROC”) insight. The ROC insight GUI can facilitate exploration of classification, performance, or statistics related to selected models. The ROC insight can be provided or generated for binary classification problem types.

FIG. 2E illustrates a graphical user interface for a prediction different insight. The prediction difference insight can provide or indicate mismatches in a form of a histogram that shows one or more of: (i) percentage of predictions with a threshold precision; (ii) a percentage of predictions more than a threshold precision higher; or (iii) a percentage of predictions more than a threshold percentage lower.

With the prediction match function depicted in FIG. 2E, the system can indicate whether the challenger model performs the same as the primary model. The system can confirm that the steps of the model or operations of the model were performed in the same manner. For example, a conversion process may change an order of operations, such that there may be not be an improvement in accuracy, but the challenger model may yet perform faster or more efficiently, such as by using fewer computational resources, as compared to the primary model.

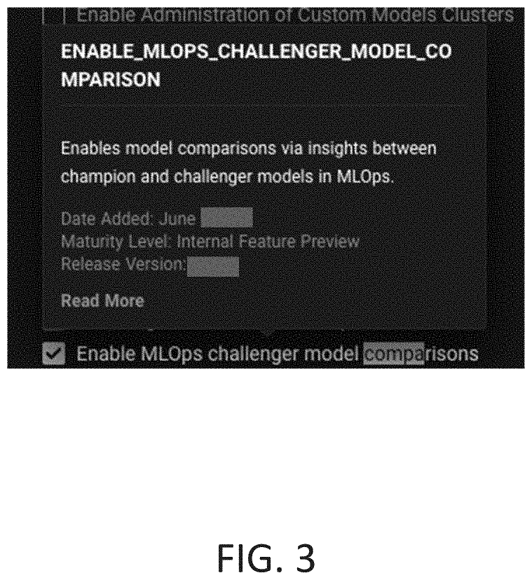

FIG. 3 illustrates a GUI provided by a system whereby a user can select whether to activate or trigger this technical solution of the challenger framework to allow model comparisons via insights between a champion model and a challenger model in machine learning operations.

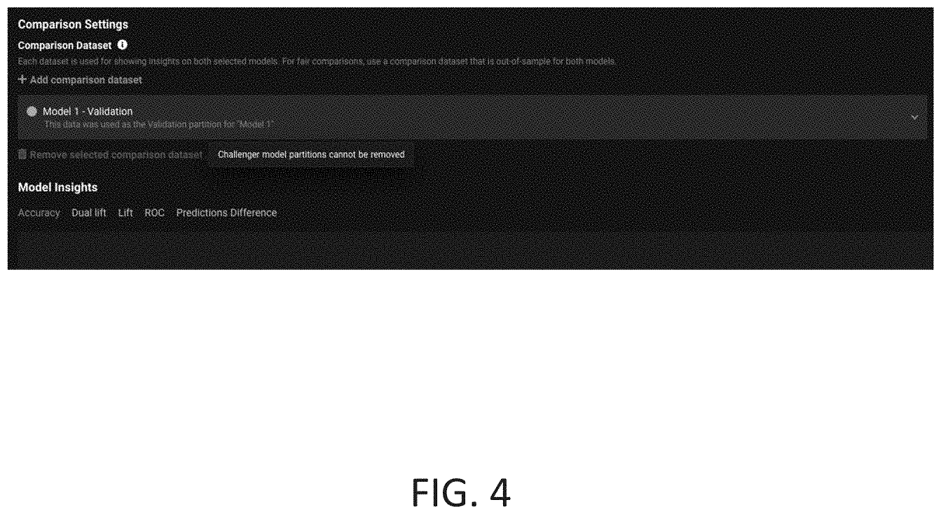

FIG. 4 illustrates a GUI in which a user can provide comparison settings, including which models to be compared, and the types of insights (e.g., accuracy, dual lift, lift, ROC, and/or prediction difference).

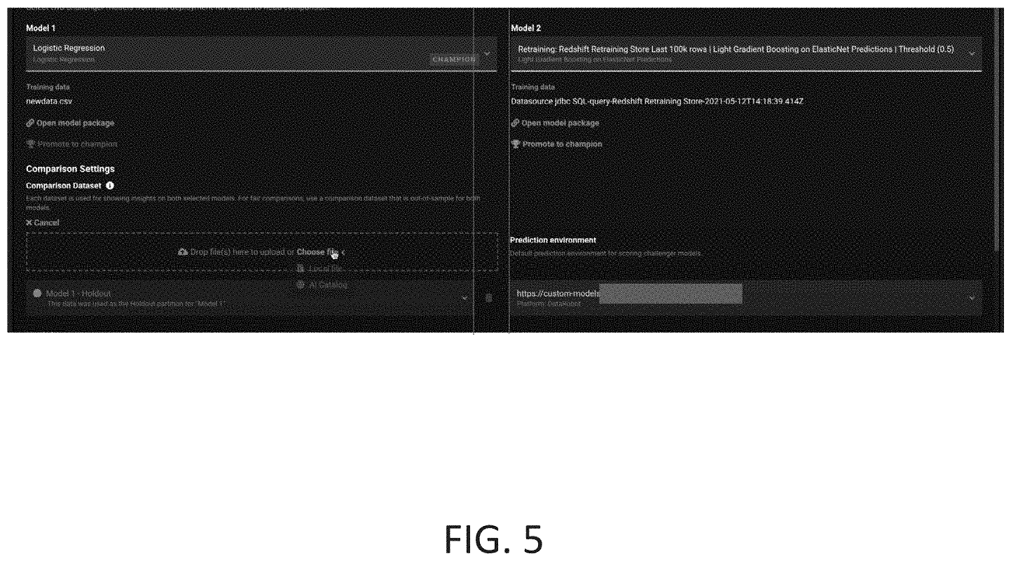

FIG. 5 illustrates a GUI in which a the system can receive inputs from user setting associated with comparing two different models, such as model attributes (e.g., training data), prediction environment, holdout data, and the like.

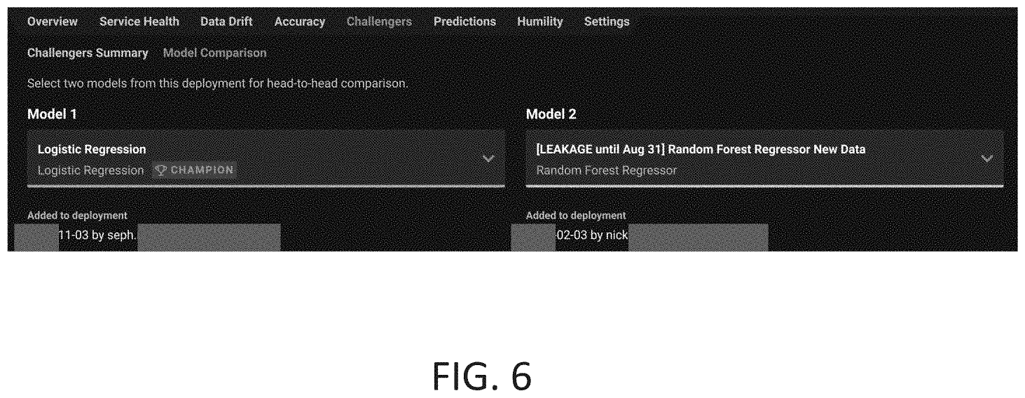

FIG. 6 illustrates a GUI in which a user can select models to be compared using the methods and systems described herein. The input elements (e.g., drop down menus) depicted in FIG. 6 can be prepopulated to show the champion model (on the left side) and other models (on the right side).

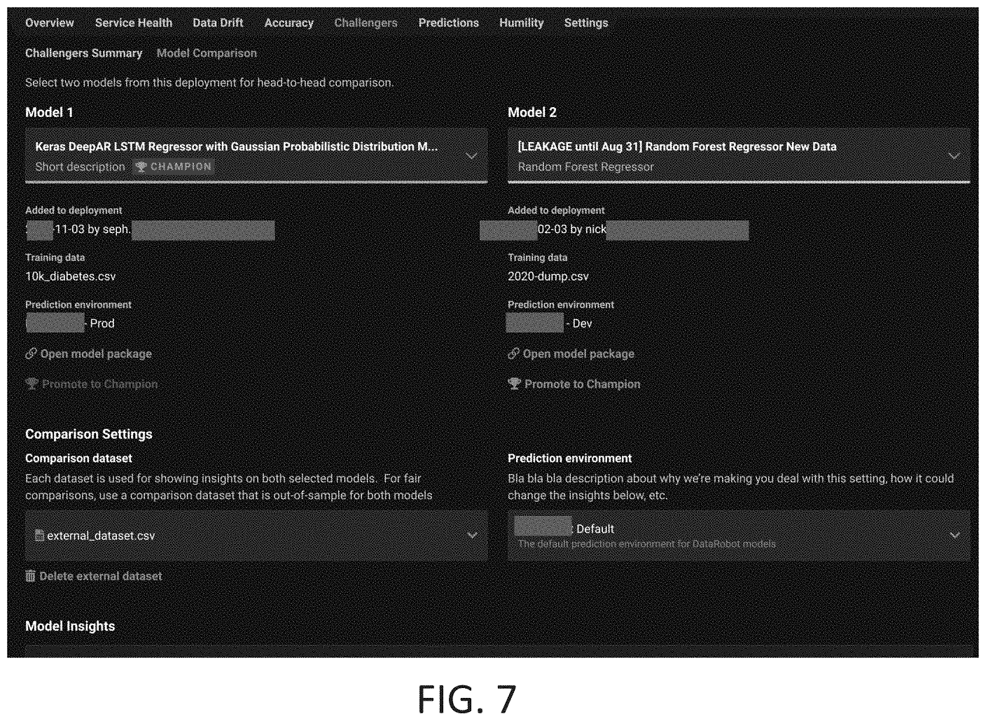

FIG. 7 illustrates a GUI in which external datasets can be provided. The system can use the external dataset for comparison. The data set can be used to show insights on both selected models, such as Model 1 and Model 2 depicted in FIG. 7. The comparison dataset can be out-of-sample for both models.

If no challengers is created, Model 2 selector may be used as a shortcut for challenger creation. Default models for comparison may be be selected—champion+1st challenger in the list. Using the GUI depicted in FIG. 7, user can switch any model in the dropdown menu. In some embodiments, by default, the Champions Holdout dataset may be selected. Users can select one or more of available datasets for comparison, such as models validation and holdout datasets and/or the ability to select any dataset from a predetermined catalog. Once a dataset from AI catalog is selected for calculating insights for a particular deployment, it may persist in the dataset selection dropdown for this deployment.

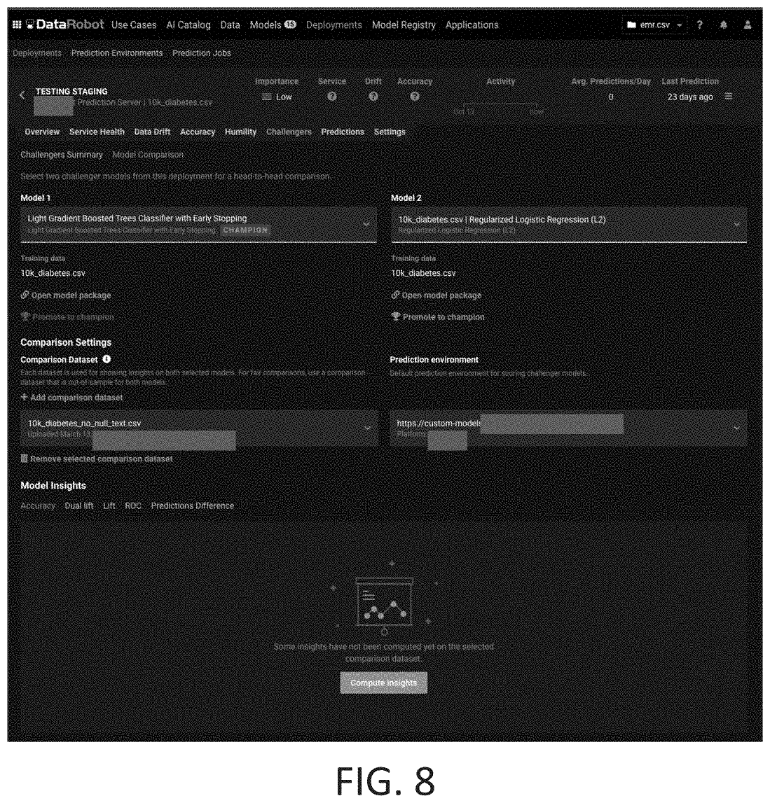

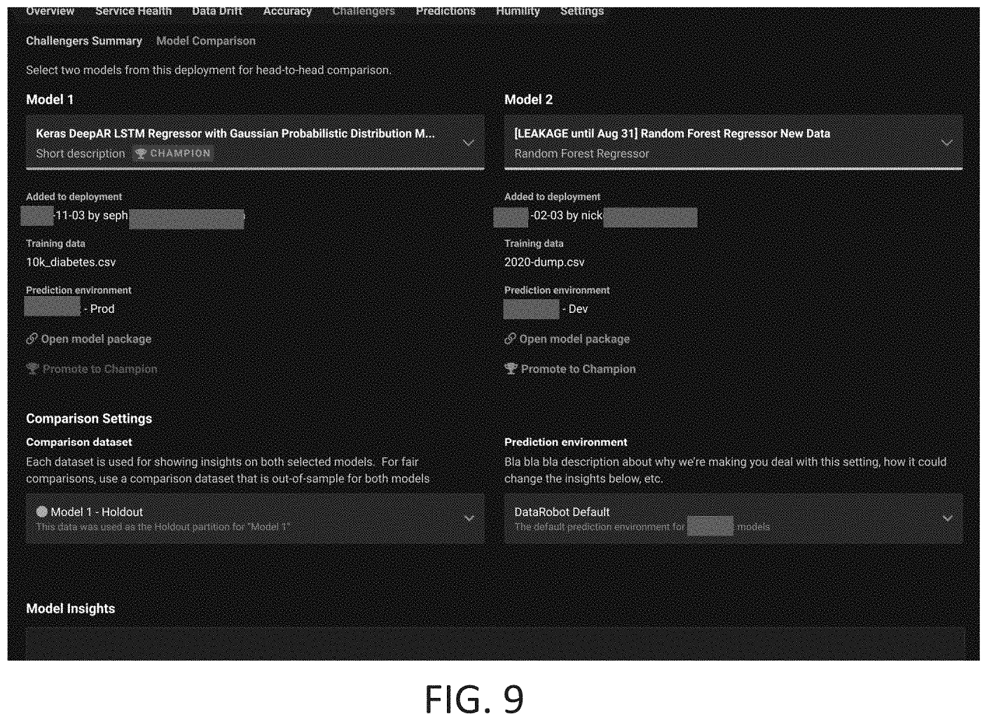

FIG. 8 illustrates a GUI in which comparison settings can be provided. The system can use the comparison settings for comparison of the champion and challenger models. A user operating the GUI depicted in FIG. 8 can add comparison dataset that can be used by the system to compare both models, such that the results are consistent for both models. In some configurations, as depicted in FIG. 9, the system may receive an instruction and identification of holdout data to be used.

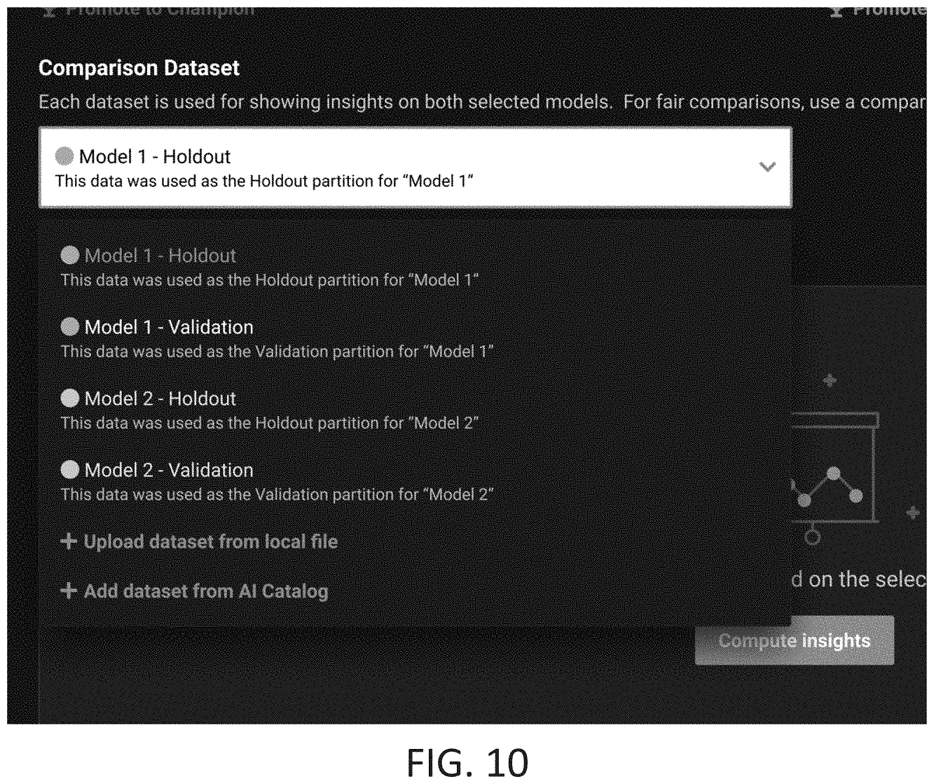

FIG. 10 illustrates a graphical user interface with a tab under a challengers tab. If no challengers have been created yet, Model 2 selector can provide a shortcut for challenger creation. Default models for comparison can be selected−champion+1st challenger in the list. Using the GUI, users can switch between models in the dropdown (comparing model to itself should not be possible). A promote to champion button can route the user to overview tab with opened replacement menu. By default, a Champions Holdout dataset can be selected. Users can select one of available datasets for comparison which includes: first and second models validation and holdout datasets in conjunction with the ability to select any dataset from AI catalog. Once a dataset from AI catalog is selected for calculating insights for a particular deployment, the selected dataset can persist in the dataset selection dropdown for this deployment. If model's validation or holdout dataset is selected, the selection can have a corresponding legend color assigned. When selected, dataset Comparison Insights may show calculated data for selected models and dataset if it already exists or user can click on Run button to start calculation job. User can select a prediction environment from the dropdown. Selected challenger models can be scored using this environment.

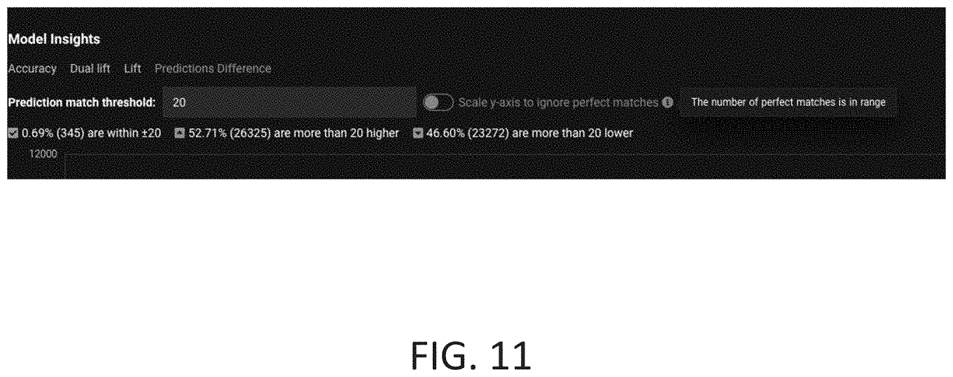

FIG. 11 illustrates a GUI configured to receive a prediction match threshold from a user. The system may use the threshold received from the GUI to compare the models. As discussed herein, the prediction match threshold may refer to a tolerable threshold for a difference of a prediction generated by each model where the predictions correspond to the same data point. For instance, the challenger model and the champion model may analyze the same data point(s) and generate two different prediction values. The prediction match threshold may indicate a tolerable amount of difference between the prediction values. The prediction match threshold may be received in a numerical form that represents a percentage of difference or an absolute value of the difference.

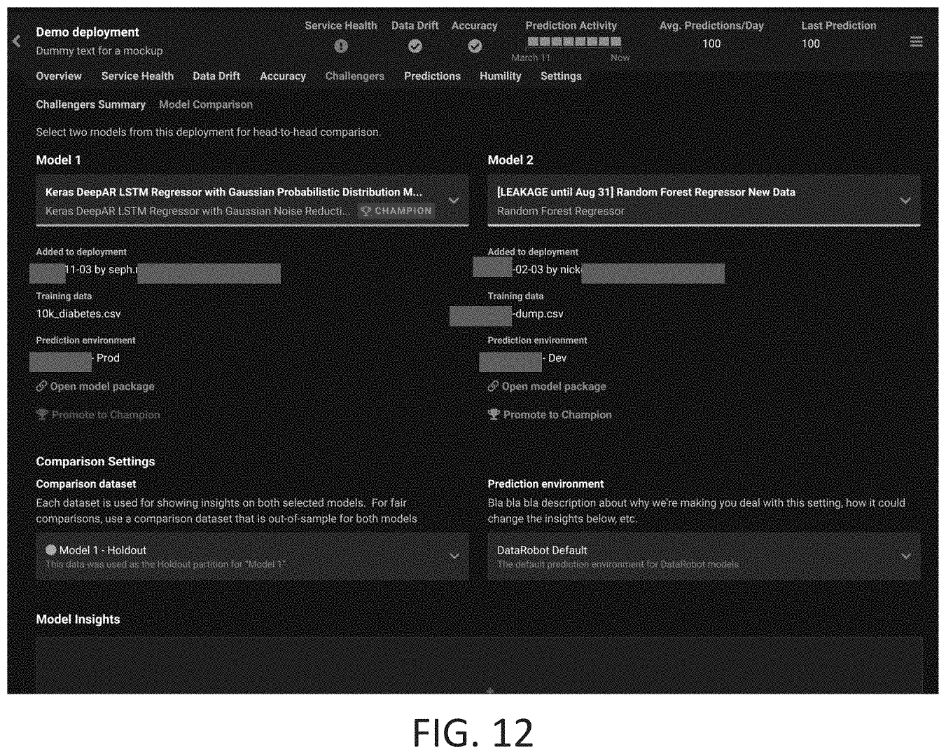

FIG. 12 illustrates a page used by users to create customized charts comparing a plurality of models. Specifically, the depicted GUI may include various input elements configured to receive attributes, timelines, and other criteria needed to compare models. In some configurations, a challenger may outperform the champion in one attribute (e.g., accuracy attribute or performance attribute). However, the champion may outperform the challenger in another attribute. Similarly, certain models may perform differently using different training datasets.

Using the input elements depicted in FIG. 12, a user may input which models to be compared, which training data to be used, which prediction environment is to be used, and other attributes needed for the comparison charts to be created.

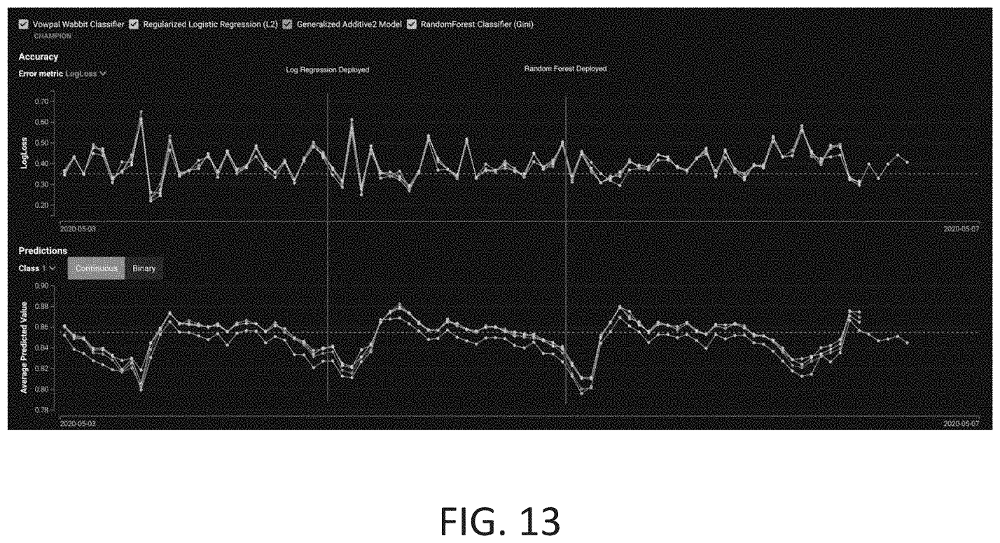

FIG. 13 illustrates a chart that displays a visual comparison of various models. Specifically, FIG. 13 includes a chart that visualizes how different models perform with regard to accuracy over time. The charts may include various data points arranged on a Y-axis that corresponds to an accuracy attribute of each model (e.g., log loss or an evaluation of an average predicted value) and an X-axis that corresponds to a timestamp of each data point. The chart depicted in FIG. 13 may correspond to the values received in response to displaying the graphical user interface depicted in FIG. 12.

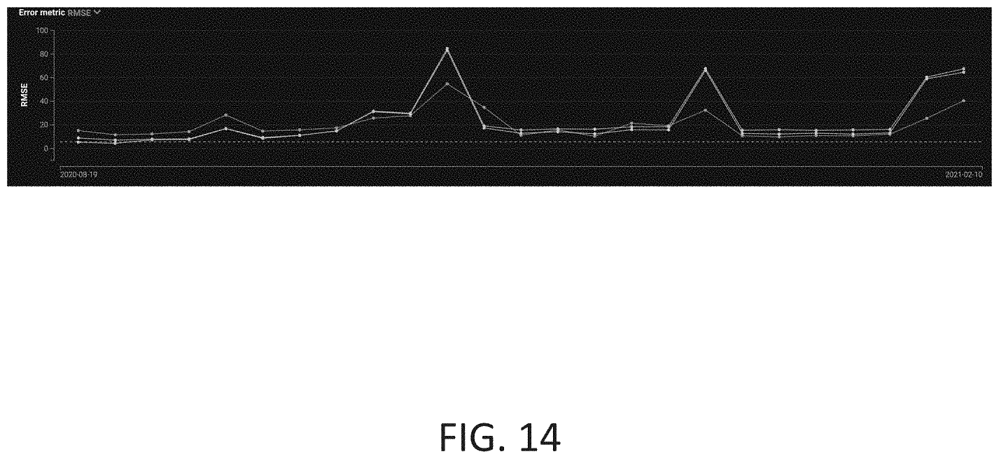

FIG. 14 illustrates a chart that, similar to the chart depicted in FIG. 12, compares different models' performance with respect to a particular attribute. In the depicted embodiment, the chart compares multiple models and their corresponding to a Root Mean Square Error (RMSE) value. The RMSE value may refer to a metric of prediction quality of each model. Specifically, RMSE value may illustrate how far predictions by a model fall from measured true values using Euclidean distance.

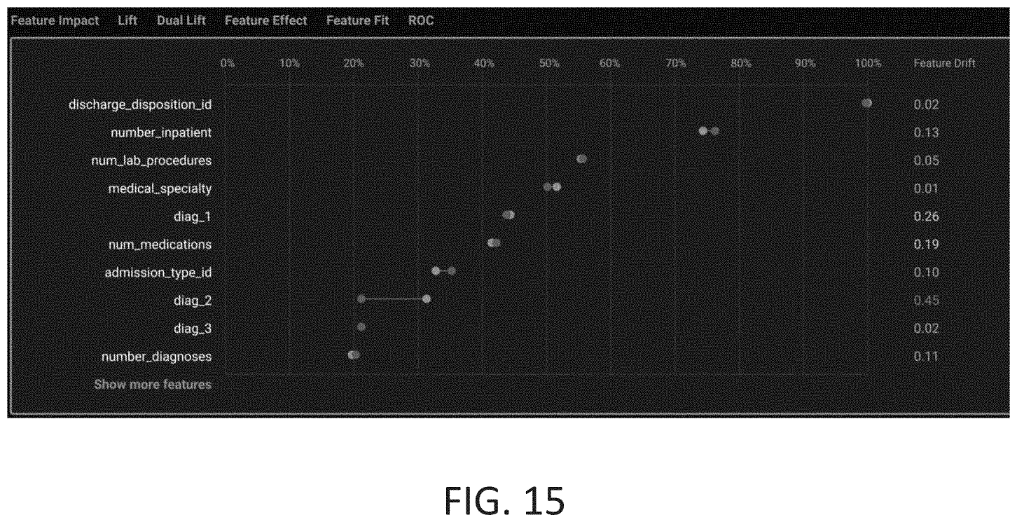

FIG. 15 illustrates may visually compare different features used by one or more models and their corresponding impact. The chart depicted in FIG. 15 may also depict a drift value associated with each feature. As a result, a viewer can easily identify that a model's perform is not satisfactory because a feature with high impact (e.g., a feature that is important to the model) has a high drift value. Also, the viewer may analyze the model's performance based on a range of impact associate with each feature.

After deploying models and/or changing model configurations, such as changing a primary model with the challenger model, the system may retrain the formerly-primary model. For instance, the model (that was the primary model and now the challenger) may be retrained, such that its performance is improved.

In some embodiments, the system may monitor performance of the first and second model after the second model (challenger model) is deployed as the primary model. The system may then determine that the second model (now deployed as the primary model) may be experiencing an error or a performance drop (e.g., drift or lowering in one or more of the performance metrics). The system may then prompt one or more users regarding this error or lowering of the performance metric. The system may then (either automatically or upon receiving an authorization from the user) change the primary model. For instance, the system may switch the models back (change the primary to challenger and the challenger, which was the original primary model, to the primary model). In this way, the better model may be dynamically identified and used at any time.

FIG. 16 is a block diagram of an example computer system 1600. The computer system or computing device 1600 can include or be used to implement the systems, methods or graphical user interfaces depicted herein. The computing system 1600 includes a bus 1605 or other communication component for communicating information and a processor 1610 or processing circuit coupled to the bus 1605 for processing information. The computing system 1600 can also include one or more processors 1610 or processing circuits coupled to the bus for processing information. The computing system 1600 also includes main memory 1615, such as a random access memory (RAM) or other dynamic storage device, coupled to the bus 1605 for storing information, and instructions to be executed by the processor 1610. The main memory 1615 can be or include the data repository. The main memory 1615 can also be used for storing position information, temporary variables, or other intermediate information during execution of instructions by the processor 1610. The computing system 1600 may further include a read only memory (ROM) 1620 or other static storage device coupled to the bus 1605 for storing static information and instructions for the processor 1610. A storage device 1625, such as a solid state device, magnetic disk or optical disk, can be coupled to the bus 1605 to persistently store information and instructions. The storage device 1625 can include or be part of the data repository.

The computing system 1600 may be coupled via the bus 1605 to a display 1635, such as a liquid crystal display, or active matrix display, for displaying information to a user. An input device 1630, such as a keyboard including alphanumeric and other keys, may be coupled to the bus 1605 for communicating information and command selections to the processor 1610. The input device 1630 can include a touch screen display 1635. The input device 1630 can also include a cursor control, such as a mouse, a trackball, or cursor direction keys, for communicating direction information and command selections to the processor 1610 and for controlling cursor movement on the display 1635. The display 1635 can be part of the data processing system, the client device or other component, for example.

The processes, systems and methods described herein can be implemented by the computing system 1600 in response to the processor 1610 executing an arrangement of instructions contained in main memory 1615. Such instructions can be read into main memory 1615 from another computer-readable medium, such as the storage device 1625. Execution of the arrangement of instructions contained in main memory 1615 causes the computing system 1600 to perform the illustrative processes described herein. One or more processors in a multi-processing arrangement may also be employed to execute the instructions contained in main memory 1615. Hard-wired circuitry can be used in place of or in combination with software instructions together with the systems and methods described herein. Systems and methods described herein are not limited to any specific combination of hardware circuitry and software.

Although an example computing system has been described in FIG. 16, the subject matter including the operations described in this specification can be implemented in other types of digital electronic circuitry, or in computer software, firmware, or hardware, including the structures disclosed in this specification and their structural equivalents, or in combinations of one or more of them.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “data processing system” “computing device” “component” or “data processing apparatus” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 1600 can include clients and servers. A client and server are generally remote from each other and typically interact through a communication network (e.g., the network 101). The relationship of client and server arises by virtue of computer programs running on the respective computers and having a client-server relationship to each other. In some implementations, a server transmits data (e.g., data packets representing a digital component) to a client device (e.g., for purposes of displaying data to and receiving user input from a user interacting with the client device). Data generated at the client device (e.g., a result of the user interaction) can be received from the client device at the server.

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system, comprising:
one or more processors, coupled to memory, to:
determine, based on a comparison of a first model that is deployed as a primary model with a second model that is acting as a challenger model, that the second model performs better than the first model based on at least one performance metric;
determine, based on a comparison of a characteristic of the first model with a characteristic of the second model, to skip a validation process for the second model; and
establish the second model as the primary model in the deployment to replace the first model in the deployment.

2. The system of claim 1, wherein the characteristic comprises a blueprint.

3. The system of claim 1, wherein the characteristic comprises a hyperparameter.

4. The system of claim 1, wherein the characteristic comprises an order of operations.

5. The system of claim 1, wherein the one or more processors are further configured to:
determine, based on the first model, one or more performance metrics to use for the comparison of the first model with the second model;
provide the determined one or more performance metrics for presentation via a prompt output by a graphical user interface rendered on a client device;
receive, responsive to the prompt, a selection of the at least one performance metric from the one or more performance metrics provided via the prompt.

6. The system of claim 1, wherein the one or more processors are further configured to:
detect, subsequent to deployment of the second model as the primary model, an error with output or performance of the second model; and
return, responsive to the detection, the first model as the primary model in the deployment.

7. The system of claim 1, wherein the one or more processors are further configured to:
provide, responsive to the determination that the second model performs better than the first model and to skip the validation process, a prompt to a client device to request authorization to establish the second model as the primary model in the deployment; and
establish the second model as the primary model in the deployment responsive to receiving authorization from the client device via the prompt.

8. The system of claim 1, wherein the at least one performance metric comprises at least one of speed of performance, accuracy, or computation resource utilization.

9. The system of claim 1, wherein the one or more processors are further configured to:
determine the first model performs better than the second model based on the second model generating output with a same accuracy faster than the first model.

10. A method comprising:
determining, by one or more processors coupled to memory, based on a comparison of a first model that is deployed as a primary model with a second model that is acting as a challenger model, that the second model performs better than the first model based on at least one performance metric;
determining, by the one or more processors, based on a comparison of a characteristic of the first model with a characteristic of the second model, to skip a validation process for the second model; and
establishing, by the one or more processors, the second model as the primary model in the deployment to replace the first model in the deployment.

11. The method of claim 10, wherein the characteristic comprises a blueprint.

12. The method of claim 10, wherein the characteristic comprises a hyperparameter.

13. The method of claim 10, wherein the characteristic comprises an order of operations.

14. The method of claim 10, comprising:
determining, based on the first model, one or more performance metrics to use for the comparison of the first model with the second model;
providing the determined one or more performance metrics for presentation via a prompt output by a graphical user interface rendered on a client device;
receiving, responsive to the prompt, a selection of the at least one performance metric from the one or more performance metrics provided via the prompt.

15. The method of claim 10, comprising:
detecting, subsequent to deployment of the second model as the primary model, an error with output or performance of the second model; and
returning, responsive to the detection, the first model as the primary model in the deployment.

16. The method of claim 10, comprising:
providing, responsive to the determination that the second model performs better than the first model and to skip the validation process, a prompt to a client device to request authorization to establish the second model as the primary model in the deployment; and
establishing the second model as the primary model in the deployment responsive to receiving authorization from the client device via the prompt.

17. The method of claim 10, wherein the at least one performance metric comprises at least one of speed of performance, accuracy, or computation resource utilization.

18. The method of claim 10, comprising:
determining the first model performs better than the second model based on the second model generating output with a same accuracy faster than the first model.

19. A non-transitory computer-readable medium storing processor-executable instructions that, when executed by one or more processors, causes the one or more processors to:
determine, based on a comparison of a first model that is deployed as a primary model with a second model that is acting as a challenger model, that the second model performs better than the first model based on at least one performance metric.
determine, based on a comparison of a characteristic of the first model with a characteristic of the second model, to skip a validation process for the second model; and
establish the second model as the primary model in the deployment to replace the first model in the deployment.

20. The computer-readable medium of claim 19, wherein the characteristic comprises a blueprint.
